(19) United States
(12) Patent Application Publication
(10) Pub. No.: US 2014/0120511 A1
(43) Pub. Date: May 1, 2014

(54) TeachAtCafe - TeaChatCafe, Transparent Digital and Social Media as an Open Network Communication and Collaboration Tool with User Driven Content and Internet Content Submission Capability for Educators and Their Students

(71) Applicant: Sharon L. Hall, Cincinnati, OH (US)

(72) Inventor: Sharon L. Hall, Cincinnati, OH (US)

(21) Appl. No.: 14/046,971

(22) Filed: Oct. 6, 2013

Related U.S. Application Data
(60) Provisional application No. 61/710,760, filed on Oct. 7, 2012.

(51) Int. Cl. G09B 5/02

(52) U.S. Cl. CPC G09B 5/02
USPC 434/350

(57) ABSTRACT

A method, systems, and computer programming products that support transparent, safe online communication and collaboration for educators and their students participating in any K-12 or higher-education institutions. A software application is provided as a framework that allows teachers and students to reach out to one another digitally and from a variety of social media technologies without social entanglement and in a completely transparent way. This invention provides a method, system and software application that pushes all chatting/texting/messages and other user driven content between two users to a monitoring portal that allows school administrators and parents to view all digital communication between their students and educators. In addition, automated keyword searches run in the background that will alert monitors of misconduct or inappropriate language. All system registrants are informed and agree to the transparent dialog before use.

### STATEMENT REGARDING FEDERALLY SPONSORED RESEARCH OR DEVELOPMENT

Research and development of the present invention and application have not been federally sponsored, and no rights are given under any Federal program.

### CROSS-REFERENCE TO RELATED APPLICATIONS

None

### REFERENCE TO A MICROFICHE APPENDIX

Not applicable.

### BACKGROUND OF INVENTION

1. Field of the Invention

This invention relates to the need of educators to connect with students digitally and online for improved communication and collaboration. Specifically within the K-12 grades, teachers are faced with significant exposures related to private digital communications with students. However, with the daily advances of the internet and related communication tools, teachers are experiencing a significant disconnect from their students. This invention supports the use of digital communication between teachers and students in a safe and transparent manner, while discouraging misconduct. With the availability of this new designed method and computer-based apparatus and software there will no longer be a need for a teacher to communication digitally with a student in a cloaked and private manner.

2. Relevant Background

a.) School districts across the country are banning the use of social media as a collaboration and communication tool for teachers and students and in some cases the use of any form of digital communication is banned.
a. Social media is an integrated Web-based technology that allows users to generate content and then share that content through various connections. Examples of social media include blogs, social networking sites, microblogging sites, photo and video sharing sites, wikis, mashups, and virtual worlds.
b. With millions of active users on hundreds of sites, social media has become the way people do business, engage with others, and share and gather information. Social media is one of the many tools organizations can use to communicate with their community.

3. Relevant Background (Continued)
a. Social media giant, Facebook, reports recently that the platform has reached one billion users a month.
b. “ . . . it makes it very easy for teachers to form intimate and boundary-crossing relationships with students . . . ”—Charol Shakeshaft, State Chairwoman for the Dept of Education
c. New York City School District reports a steady increase in the number of complaints of inappropriate communications involving Facebook alone in recent years:
   Only 8 complaints reported from September 2008 to October 2009
   Increased to 85 complaints reported from January 2010 thru September 2011
d. Teachers and coaches are jailed on sexual abuse and assault charges after having relationships with students that, law enforcement officials say, began with electronic communication.

b.) The vast majority of teachers use social media appropriately and are actively protesting banning. School teachers have been able to engage some students on social media who would not raise their hand in class and say that social media networks allow them to collaborate on projects and in other parts of the country.
a. School administrators are also concerned about teachers who use the platforms appropriately but simply reveal too much information about their private lives.

c.) Teenagers no longer use email and spend 80% of their time online on social media networks.
a. According to PEW Research Center people between the ages of 18 and 24 now send/rec on average 3200 text messages a month.

Three (3) Clear Problems for Educators with Regards to Social Media and Other Forms on Digital Communication have been Identified:
1.) The private and intimate nature of the messaging and text features on Facebook and other social and communications/collaboration platforms have been identified as the “boundary crossing,” contributors.
2.) The very nature of social media platforms and their use requires the intermingling of users' social lives. It is important for both teachers and students to keep their social lives separate.
3.) Teachers need to reach students electronically and students spend 80% of their time online on social media, collaborative technologies that allow for private conversation and user driven content sharing.

4. Description of the Related Art Including Information Disclosed Under 37 CFR §§1.97-1.98

The prior art discloses a number of designs which are somewhat relevant but fail to disclose the invention claimed herein.
U.S. Pat. No. 8,010,662, disclosed a computational method soliciting data indicating at least one subjective user state in response to acquisition of data indicating at least one objective occurrence.
U.S. Pat. No. 8,010,663, disclosed a computational method indicating subjective user states associated with multiple users with data indicating objective occurrences.
U.S. Pat. No. 8,010,664, disclosed a computationally method that allows for hypothesis development based on selective reported events.

U.S. Pat. No. 8,028,063, disclosed a computational method soliciting data indicating at least one objective occurrence in response to acquisition of data indicating at least one subjective occurrence.
U.S. Pat. No. 8,073,807, disclosed a methods and apparatus, including computer program products, implementing and using techniques for estimating an actual age of a member of a website.
U.S. Pat. No. 8,180,752, disclosed a methods and apparatus include features for managing a social media universes. In one embodiment, media content and community members that have been associated with a new concept for creating a new universe are searched on a plurality of media content servers. For each found new concept, an association is retained between the new universe for the new concept and any found media content and community members. When a requesting user requests to view the new universe, a representation of the media content and the community members that are associated with the new universe is displayed for the requesting user.
U.S. Pat. No. 20100151431, disclosed a questionnaire server capable of providing questionnaires based on device capabilities.
U.S. Pat. No. 8,181,111 B1, disclosed a system and method for providing social context to digital activity.
U.S. Pat. No. 8,190,475, disclosed a website visitor profile modeling method and systems.
U.S. Pat. No. 4,887,212, disclosed a parser for natural language text.
U.S. Pat. No. 5,115,466, disclosed a communication network intended for secure transmission of speech and data, including different types of subscriber and switching modules and where the network further comprise crypto devices to undertake encryption/decryption of information transmitted through the network. At least one of the crypto devices is constituted by a crypto-pool device having a number of crypto modules (CM) physically separated from the switching modules.
U.S. Pat. No. 5,392,390, disclosed a method is disclosed for the translation of dissimilarly-formatted data between disparate computer applications and platforms. The method also provides for the dynamic reconciliation of conflicts in the data (for example, two appointments scheduled at the same time) based on both the content of the data and on specific preferences indicated by the user of the translation facility.
U.S. Pat. No. 5,682,524, disclosed a databank system with methods for efficiently storing non-uniform data records.
U.S. Pat. No. 5,706,509, This invention relates to a system and method for interactive, adaptive, and individualized computer-assisted instruction. This invention includes an agent for each student which adapts to its student and provides individualized guidance to the student and controls to the augmented computer-assisted instructional materials. The instructional materials of this invention are augmented to communicate the student's performance and the material's pedagogical characteristics to the agent and to receive control from the agent. Preferably, the content of the communication between the agent and the materials conforms to specified interface standards so that the agent acts independently of the content of the particular materials. Also preferably, the agent can project using various I/O modalities integrated, engaging, life-like display persona(e) appropriate to the preferences of its student and appear as a virtual tutor to the student.
U.S. Pat. No. 5,778,367, disclosed a computer network and a database are used to provide a hardware-independent, dynamic information system in which the information content is entirely user-controlled. Requests are received from individual users of the computer network to electronically publish information, and input is accepted from the individual users. Entries from the users containing the information to be electronically published are automatically collected, classified and stored in the database in searchable and retrievable form. Entries are made freely accessible on the computer network. In response to user requests, the database is searched and entries are retrieved. Entries are served to users in a hardware-independent page description language. The entries are password protected, allowing users to retrieve and update entries by supplying a correct password. Preferably, the process is entirely automated with any necessary billing being performed.
U.S. Pat. No. 6,006,215, disclosed methods and apparatus for improved contact and activity management and planning where subject data, activity data and topic data are created and functionally linked through interfaces and processing modules to organize information in a useful way that permits system users to have access to the information they need to conduct business in an efficient and productive manner.
U.S. Pat. No. 6,810,411 disclosed an establishment of an envoy may be subjected to a myriad of tests to “qualify” the user, the requested communication, or both. Therefore, a high level of security may be achieved. The usual added burden of prior-art proxy systems is avoided in such a way as to achieve full transparency the user can use standard applications and need not even know of the existence of the firewall. To achieve full transparency, the firewall is configured as two or more sets of virtual hosts.
U.S. Pat. No. 7,539,697, disclosed a relationship graph representing a social network connecting multiple entities is created and maintained as nodes and edges. Data received for an entity is used to create a new node. A strength of relationship value is calculated for each relationship between the new entity and an entity represented by an existing node and assigned to an edge is created to represent each relationship. Data received for an existing node causes the node to be updated, and the strength of relationship values for each of its relationships to be recalculated and assigned to the appropriate edge. More than one node may exist for an entity and conflicts among the data of the multiple nodes are reconciled. The received data may be extracted from data sources owned by a user in accordance with privacy criteria for the user, or may result from processing data in the relationship graph.
U.S. Pat. No. 20050216300, disclosed that social network information may be shared across online service providers. Thus, one online service provider M that maintains a membership separate from a second online service provider N may nevertheless use the social network maintained by the second online service provider N to tailor content and/or services based on such social network information.
U.S. Pat. No US200800005282, disclosed a method and apparatus is provided for use with a web browser for managing and automating the use of social networks and other web sites. For example, users can associate user generated content with third party web pages and to customize the visibility of this content based on multiple modes of authentication. Users may also manage personal profiles and contact lists over multiple social networks. Users can even monetize their popularity by hosting advertisements and being paid based on their respective level of viewer ship. Various other features are also available for use by users that will enhance their social networking experience and provide the users with increased control of their personal profiles.
U.S. Pat. No. 20080039020, A method of social networking is disclosed. The method displays a user name on a web page. Further, the method receives an input that selects the user name. The method displays a display cloud, for the user name that is selected, that illustrates at least a subset of a personal cloud of the user associated with the user name. Furthermore, multi-level tagging for content can be used in order to generate tag clouds.
U.S. Pat. No. 20090294768, Embodiments of the invention are directed to identifying network resources or other topics that are of interest to members of multiple online communities to which a user belongs. Online communities include blogs, websites, games, e-commerce systems, messaging systems, wikis, etc. For each online community, click activity or other client behaviors are tracked and analyzed to determine statistical metrics about community activity, such as which articles, links, services, or other network resources are popular in the online community. At least some of the tracking or analysis can be performed by clients that access the online communities, by a server of each online community, and/or by a central tracking system. The results for each community may be further analyzed relative to each other. The results are provided for all communities with which a given user is associated. For example, a list of the most popular links in the user's selected online communities.
U.S. Pat. No. 20090138546, This invention is an electronic communication system for wireless mobile devices and is utilized to scan for the existence of other wireless mobile devices, analyze and present information regarding user profiles associated with each device, and provide functionality to initiate possible social interactions between users of these devices.
U.S. Pat. No. 5,002,491, disclosed an interactive electronic classroom system for enabling teachers to teach students concepts and to receive immediate feedback regarding how well the students have learned the concepts. Structure is provided for enabling students to proceed in lockstep or at their own pace through exercises and quizzes, responding electronically to questions asked, the teacher being able to receive the responses, and to interpret a readout, in histogram or other graphic display form, of student responses. In a preferred embodiment, a central computer using an IBM AT™ compatible system is employed, together with a plurality of student computers which range from simple devices to full-fledged personal computers. Optical peripheral hardware, such as VCRs or other recording/reproducing devices, may be used to provide lessons to students in association with the computer network.
U.S. Pat. No. 5,176,520, disclosed a computer assisted instructional information delivery system having at least two stations. One station for an instructor and one or more stations for students. An interactive monitor is positioned in each station. Each interactive monitor displays instructional information in visual form as inputted by a stylus or light pen on the interactive monitor. A network communication system operated by a central processing unit and corresponding software, communicates the instructional information from the stylus as inputted on one of the interactive monitors and selectively displays the instructional information simultaneously and concurrently onto any or all of the interactive monitors of the stations.
U.S. Pat. No. 5,263,869, disclosed a computerized teaching system is described, which comprises an interactive group communication system, wherein students in a first group interact with a teacher in Social Mode, and, in some case, while students in a second group proceed with work in Independent Mode.
U.S. Pat. No. 5,344,326, There is disclosed an affordable method and system of fully automating the instruction of a plurality of students which incorporates the use of a single CPU in conjunction with student questioning, responding and information feedback devices and which no longer relies upon the ability, mindset or even presence of a classroom teacher. The method further includes a fully-automated directly-integrated marks, records, reports and lesson management system.
U.S. Pat. No. 5,437,555, disclosed a computerized teaching system is described including an interactive group communication system, wherein students interact with a teacher and the teacher can obtain quantitative reports on student performance without preprogrammed lessons and where a lesson program can be constructed from the responses of the students. The teaching system may be spread over a large geographic area comprising a multiplicity of learning centers with a multiplicity of students at each center, wherein the students interact with a teacher who is remotely located from one or more learning centers.
U.S. Pat. No. 5,788,508, disclosed an educational method and system for executing the method, to improve the efficiency of individual learning by monitoring the student's progress and pacing the course material to the student's ability to comprehend and learn. This method and system also reduces the teachers' administrative and paperwork burden. Interactive multimedia technology is combined with unique courseware development to provide a flexible teaching tool and student monitoring system.
U.S. Pat. No. 5,823,788, disclosed an interactive instructional system includes a microprocessor-controlled base station for use by an instructor and/or a computer and a plurality of input devices each for use by a student. The base station and input devices communicate over a communication link or network employing wires, optical fibers, radio links, infrared links or the like. Each input device is in the form of a multiple keyswitch operated device which the student may operate to respond to a question posed by the instructor, computer or base station during a lecture. Each input device is also provided with an identifier code. Responses by the student are transmitted to the base station in messages, each of which further includes an identifier code thereby identifying the answering device or student. The base station receives the students' responses from the input devices and generates information for display to the instructor, including selected class and individual statistics.
U.S. Pat. No. 5,957,699, disclosed a student user of a client computer system uses a teaching process to promote development of cognitive skills of the student and a supervisor uses a second client computer to remotely monitor the progress of the student. The teaching process presents various types of stimuli to the student and records student response data which correspond to the stimuli. In addition, the teaching process forms evaluation data from the student response data where the evaluation data represents a correlation between the student response data for respective stimuli and predetermined correct response data for respective stimuli. Furthermore, the teaching process modifies its own behavior according to the evaluation data to thereby tailor the behavior of the teaching process to the cognitive abilities of the student. The student response data is uploaded to a global student database which is accessible to a supervisor user. The supervisor requests student response data from the global student database.
U.S. Pat. No. 5,978,648, disclosed an interactive multi media performance assessment system and process for use by students for creating multi media presentations based upon the task assignments generated by a teacher and utilizing any combination of text, audio and visual input sources. A series of workfolders are created by the student to view the issued task assignments and provide a vehicle for creating the multi media presentations. Resources such as Internet based connection and various audio visual items may be utilized with the system for assisting in the creation of the presentations and both the teachers and students may provide feedback in the form of text, audio or video. Additionally, administrators can provide feedback to teachers which in turn can be utilized for evaluation and suggested improvements.
U.S. Pat. No. 6,413,100, disclosed methods and apparatus for providing a solution to a given problem comprising the steps of receiving a request for a solution to a known problem, accessing a first set of data comprising a plurality of template solutions to problems, accessing a second set of data comprising a plurality of problem variable value sets, interfacing the first set of data and the second set of data for generating a solution to the problem, and transmitting the solution over a computer network.
U.S. Pat. No. 6,461,166, disclosed a methodology in which a learner-constructed response is provided in answer to a question presented by the system, the response being evaluated by comparison with pre-defined expected responses and, based upon the evaluation, the system determining whether to proceed to another question or to offer remedial feedback. Such a learner-constructed response based evaluation methodology greatly reduces the potential for “guess-work” based correct responses and improves the training process through remedial feedback and advancement upon demonstration of knowledge.
U.S. Pat. No. 6,516,340, disclosed an Internet-enabled subscription teaching service system has an Internet-connected lecture server executing a software suite, one or more teacher-author stations coupled to the Internet-connected lecture server, having input and display apparatus, and including lecture-authoring software, and one or more Internet-capable lecture client stations having lecture-participation software. Teacher-authors use the teacher-author stations to prepare lectures through the lecture-authoring software, the lecture server stores prepared lectures and provides lectures on a pre-determined schedule to lecture clients at the lecture client stations, and the lecture clients follow the provided lectures at the lecture client stations through the lecture-participation software. Some lectures are fully automatic, and some are directed by the teacher-authors in real time. In the real time case recipients are directed to WEB pages in unison, and annotation and commentary is provided by the teacher-author.
U.S. Pat. No. 6,628,918, disclosed a system, method and computer program product are provided for giving feedback in an educational environment using networked devices. Initially, an image stimulus is displayed to a plurality of individual group members regarding material being presented by a group leader utilizing a plurality of networked devices operated by the group members. Thereafter, feedback is received from the individual group members in response to the image stimulus utilizing the networked devices. The feedback is then aggregated after which the aggregated feedback is transmitted to the networked device operated by the group leader. Such aggregated feedback reflects the feedback received from each of the individual group members for allowing the group leader to view the aggregated feedback.
U.S. Pat. No. 6,741,833, Described are a system and method for encouraging communication over a network between participants engaged in a learning activity. A communication channel is opened over the network between participants. An objective shared by the participants is presented. Cooperative interaction between the participants is required to complete the objective. Content related to the objective is displayed to each participant of the learning activity. Messages are exchanged in real-time between the participants over the communication channel to allow the participants to progress cooperatively towards completing the objective. Input from one of the participants of the learning activity is received. The input represents an action taken in response to the exchanged messages. The content displayed to the participants is dynamically updated based on the action taken by one of the participants during the learning activity, to depict progress towards the objective.
U.S. Pat. No. 6,652,287, disclosed a system and method for permitting an administrator or faculty member in an online education course to monitor and manage faculty and student activity is provided. The system includes a computer network having an administrator and instructor course management application tool for generating administrator and instructor interfaces displaying student or faculty information and facilitating an instructor's ability to manage student activities, as well as facilitating administrator management and review of both students and faculty. The method includes automatically recording student and faculty access to online educational course resources and tasks, and presenting a plurality of interactive student and faculty management selections to administrators and faculty in response to queries for student and faculty information.
U.S. Pat. No. 6,669,485, A collaborative learning system, method and computer program product permits live, real time interaction between the audience and a presenter in a controlled learning environment. The collaborative learning system, method and computer program product provides a learning process that facilitates the transfer of expertise and knowledge using “push” technology. The system includes a presenter subsystem, a backbone subsystem and an audience subsystem. The process includes pre-event, event and post-event stages. During the pre-event stage, content is created and optimized, and the producer “coaches” the presenter. During the event stage, the presenter and the producer, using the presenter subsystem, push the event material to the audience located remotely at the audience subsystem via the backbone subsystem. The event materials may comprise slides, streaming audio/video and interactive answers to questions and responses to audience feedback.
U.S. Pat. No. 6,741,833, Methods and programs are disclosed for a computer-based teaching method for various subjects, including grammar. The program includes one or more lessons to test a student's skills relative to a particular subject. A database with coded information allows a computer to search the information, such as sentences and word functions provided therein. A guide for identifying the appropriate code for each respective lesson is provided such that as a student progresses through the lessons, the computer searches the database to provide the appropriate information to the student based upon the code of the information and the guide for the respective lesson. Further, the method of coding answers to a test given with the use of a computer program is discussed. Answers given by a student are compared to the correct answers located in a computer database.
U.S. Pat. No. 6,782,396, disclosed a method, program and system aligns students and teachers according to dominant learning and teaching styles. The invention creates a menu of learning styles, and a second menu of teaching styles. Students are then tested using each learning style contained in the first menu, and the test scores are entered into a student database. Teachers are also tested using each teaching style contained in the second menu, and a database is then created for the teacher test scores. Using the student and teacher test scores, the system calculates a best-fit match between students and teachers according to corresponding learning and teaching styles.
U.S. Pat. No. 6,789,047, disclosed a system and method of evaluating the performance of an instructor of an electronic course is well suited for establishing a performance-based component of pay for the instructor to provide the instructor with a financial incentive for meeting a performance goal. A communications monitor monitors quantitative performance data on the instructor and students participating in an electronic course. A first database 32 stores the monitored quantitative performance data. A data processor determines at least one quantitative evaluative factor of a course attendance factor and an instructor response time based on the quantitative performance data. The communications monitor facilitates the gathering of qualitative performance data in a second database. The qualitative performance data may be reviewed to form a qualitative evaluation report of the instructor.
U.S. Pat. No. 6,790,045, disclosed a method and system for analyzing student performance defines student performance by classifying student performance into discrete performance classifications associated with corresponding activities related to the electronic course. An observed student performance level for at least one of the performance classifications is measured. A benchmark performance level or range is established for one or more of the performance classifications. It is determined whether the observed student performance level is compliant with the established benchmark performance level for the at least one performance classification. Instructive feedback is determined for the observed student based upon any material deviation of the observed student performance from at least one of the following: the benchmark performance level, the benchmark performance range, a group of benchmark performance levels, and group of benchmark performance ranges.
U.S. Pat. No. 6,932,612, disclosed learning materials each of which consists of learning material units are stored in a learning material DB. Keywords corresponding to the respective learning materials are stored in the learning material evaluating table. A keyword-unit table defines which learning material units include the respective keywords. A learner clicks an Understood button when the learner understand the current unit. After the learner finishes to attend the current learning material, the keywords corresponding to the units in which the Understood button was clicked are specified based on the keyword-unit table. A learning material whose keywords are in the best agreement with the keywords specified is selected as a learning material to improve ability of the learner in the strong field based on the learning material evaluating table. In the same manner, a learning material to supplement the weak field is selected based on a history of clicks of a Not Understood button.
U.S. Pat. No. 6,885,844, disclosed a system, method and computer program product are disclosed for providing feedback using networked devices. Initially, a plurality of response types are displayed on a plurality of networked devices. Further, a plurality of presented concepts are depicted on the networked devices. As such, users of a group are permitted to select at least one of the response types and at least one of the presented concepts. Further, the selected response type and the presented concepts are transmitted to a head of the group for providing feedback regarding material being presented by the head of the group.
U.S. Pat. No. 6,895,213, disclosed a communication system for communicating with students in an education environment includes a plurality of remote units, a base station that receives messages from the remote units, a processor, a memory, and a display simultaneously visible to all users of the remote units. The base station receives a response to a current question from a remote unit. The processor determines whether the current response is a valid response, and uses the display to visually indicate to a user of the remote unit whether the response is valid.
U.S. Pat. No. 6,898,411, disclosed a teaching and learning method and system (143, 145, 147, 148, 152) communicates exercises, including URL's of Web pages and questions related thereto. Each exercise is distributed by the teacher's computer (143), synchronously, or downloaded by a student computer (147), asynchronously. An indicator (129) used on the Web page of one computer can be viewed on the same Web page displayed on the other computers. Responses are processed by the response server (145) and by comparison and evaluation logic, and displayed contemporaneously on the teacher's computer, together with scoring information (105, 106) and with URL's (107) associated with links used on each student computer. Scores are awarded automatically, or arbitrarily by clicking on the screen (105) of the teacher's computer. A feedback signal (80) may appear on the student computer with each keystroke to indicate its correctness.
U.S. Pat. No. 6,905,341, disclosed a computer-assisted educational system. Educational courses are provided, comprising individual lessons. The lessons are stored at one, or more, servers, and are transmitted to remote computers over a network, such as an internet. Students utilize the remote computers to participate in the lessons. At any given time, the remote computer displays the lessons available to a student, so that, for a given course, the student is not held in lock-step with the other students, but may study the lesson's of the student's own choice. This freedom is subject to any requirements of certain lessons which require prerequisite lessons be completed. The prerequisites must be completed first.
U.S. Pat. No. 6,932,612, disclosed an education system includes a network, individual learning terminals, a group learning terminal and a learning management server. The individual learning terminals are connected with the network and are provided for individual learning of students. The group learning terminal is connected with the network and provided for group learning of a group of the students. The learning management server is connected with the network to provide first education modules for the individual learning to the individual learning terminals and second education modules for the group learning to the group learning terminal.
U.S. Pat. No. 7,013,109, disclosed an automated interactive form of data collection is disclosed that addresses the deficiencies of the standard method of personal interviews and the typical paper-based and computer-based surveys. Subject Matter Experts (SMEs) can provide data in a faster, more accurate and comprehensive manner, while providing the justification of their responses immediately. Using these data, an instructional analyst can continue the Instructional Systems Design process utilizing SME data that are complete and conclusive, without the need for extensive follow-up questioning. The database files generated by the survey software are available to the analyst for analysis and inclusion in the resulting training system analysis document.
U.S. Pat. No. 7,031,651, Described are a system and method for facilitating private instruction over a network between a teacher and a student. Profile information is received from each student who registers for a private course. Each student who registers for a private course is included in a list of students who are unassigned to a teacher. Each teacher who is able to teach a private course has access over the network to the list of students and the profile information of the students. One of the teachers who is able to teach a given private course is assigned to one of the students in the list of students enrolled in that given private course based upon the profile information of that student.
U.S. Pat. No. 7,058,354, Described are a system and method for encouraging communication over a network between participants engaged in a learning activity. A communication channel is opened over the network between participants. An objective shared by the participants is presented. Cooperative interaction between the participants is required to complete the objective. Content related to the objective is displayed to each participant of the learning activity. Messages are exchanged in real-time between the participants over the communication channel to allow the participants to progress cooperatively towards completing the objective. Input from one of the participants of the learning activity is received. The input represents an action taken in response to the exchanged messages. The content displayed to the participants is dynamically updated based on the action taken by one of the participants during the learning activity, to depict progress towards the objective.
U.S. Pat. No. 7,153,140, A method for creating training systems including analyzing/mapping course requirements for evaluating required knowledge/skills according to mapped subjects and defining possible failure causes, wherein each failure cause represents knowledge/skill weakness relating a certain subject or general weakness, defining knowledge/skills target level correct/wrong answers in each subject as function of the number of users, preparing a question pool, wherein each question relates to a subject knowledge/skill and/or failure cause, preparing correct and wrong answers for each question, wherein each wrong answer is related to a specific sub-subject/subject and/or to a failure cause, defining an evaluation module for assessing user knowledge/skills level based on user's success in giving correct answers in comparison to predefined target levels and type of failure causes related to the user's wrong answers, and defining exercise module for selecting sequence of questions from predefined question.
U.S. Pat. No. 7,171,155, disclosed a learner clicks “Understood” button when he or she could understand a learning material or clicks “Not Understood” button when he or she could not understand. When the “Not Understood” button is clicked, the learning server machine transmits an explanation choice information to display a Web page including a knowledge tree that shows a structure of the learning material. The Web page contains headings of explanations and choosing ratios as end-nodes of the knowledge tree. The explanation describes the learning material in detail. The choosing ratio is a ratio of each of the explanations chosen by learners who attended the same lecture using the same learning material.
U.S. Pat. No. 7,364,432, disclosed a Lock-In Training system. The Lock-In Training system can include an appropriately programmed Web site and a user computer. The Lock-In Training system can also include an appropriately programmed stand-alone computer. Some embodiments of the invention allow student users to efficiently learn materials by taking Lock-In Training courses. A Lock-In Training course may include one or more Lock-In Training sessions. These sessions may include one or more Lock-In Training parts. These parts can include a group of questions and answers. The answers can include one or more keywords. A student user can lock-in material by entering keywords in response to questions. The questions may be presented in Introductory rounds and/or Retention rounds on one or more training days.
U.S. Pat. No. 7,493,396, disclosed a system and methods for implementing education online by providing institutions with the means for allowing the creation of courses to be taken by students online, the courses including assignments, announcements, course materials, chat and whiteboard facilities, and the like, all of which are available to the students over a network such as the Internet. Various levels of functionality are provided through a three-tiered licensing program that suits the needs of the institution offering the program. In addition, an open platform system is provided such that anyone with access to the Internet can create, manage, and offer a course to anyone else with access to the Internet without the need for an affiliation with an institution, thus enabling the virtual classroom to extend worldwide.
U.S. Pat. No. 7,558,853, disclosed a system and methods for implementing education online by providing institutions with the means for allowing the creation of courses to be taken by students online, the courses including assignments, announcements, course materials, chat and whiteboard facilities, and the like, all of which are available to the students over a network such as the Internet. Various levels of functionality are provided through a three-tiered licensing program that suits the needs of the institution offering the program. In addition, an open platform system is provided such that anyone with access to the Internet can create, manage, and offer a course to anyone else with access to the Internet without the need for an affiliation with an institution, thus enabling the virtual classroom to extend worldwide.
U.S. Pat. No. 7,610,337, disclosed an Internet-enabled subscription teaching service system has an Internet-connected lecture server executing a software suite, one or more teacher-author stations coupled to the Internet-connected lecture server, having input and display apparatus, and including lecture-authoring software, and one or more Internet-capable lecture client stations having lecture-participation software. Teacher-authors use the teacher-author stations to prepare lectures through the lecture-authoring software, the lecture server stores prepared lectures and provides lectures on a pre-determined schedule to lecture clients at the lecture client stations, and the lecture clients follow the provided lectures at the lecture client stations through the lecture-participation software. Some lectures are fully automatic, and some are directed by the teacher-authors in real time. In the real time case recipients are directed to WEB pages in unison, and annotation and commentary is provided by the teacher-author.
U.S. Pat. No. 7,641,475, disclosed a pointing information extraction unit extracts pointing information indicating a pointing position and a pointing time on a slide from a slide file used in a lecture and a video file of a lecture video using a pointing device. A word information generation unit analyzes a text sentence extracted from the slide file to generate a word information file indicating a word and a position thereof. A word pointing information generation unit estimates a word closest to the pointing position on the slide to generate a word pointing information file with the pointing time assigned. A fill-in-the-blank word extraction unit extracts a word having a pointing time equal to or longer than a predetermined time from the word pointing information as a fill-in-the-blank word file. A fill-in-the-blank test question is generated by setting the fill-in-the-blank word of the slide information as a blank region.
U.S. Pat. No. 7,736,150, disclosed the invention is a system and method for conveying information, job skills, academic courses, and/or other forms of learning (collectively “education”). The subject matter being taught is organized into small modular units called content modules. Content modules can be invoked in a highly flexible manner and order, based on interactions with the user. A learning matrix selectively identifies which content module is to be subsequently invoked, on the basis of user goals, test results, prerequisites relating to the subject matter, empirical evidence relating to how persons typically learn the particular subject, prior content modules invoked by the user, and/or any other potentially relevant characteristic. By incorporating information relating to the user, the user's performance, the subject matter, and/or empirical data relating to how people learn the specific subject matter, subsequent content modules can be selected to specifically tailor the learning process to the specific.
U.S. Pat. No. 7,792,938, disclosed a data delivery apparatus communicate with a plurality of terminals via a communication network. Member table stores a member ID and attribute data of each member. When a member logs in via a terminal, its communication address is written into the table in association with its member ID. When a command requesting delivery of particular data has been received from a terminal, the delivery apparatus refers to the table, on the basis of the communication address of the terminal having transmitted the command, to determine whether the attribute data corresponding to the member ID is indicative of a predetermined attribute. If so, the delivery apparatus reads out the particular data from a database and broadcasts the particular data to all of terminal apparatus having their respective communication addresses stored in the table. The delivery apparatus can broadcast data, transmitted from a terminal, to all of the members, with reference to the table.
U.S. Pat. No. 7,840,175, disclosed a method for changing learning strategies includes presenting a training course to a learner in order based on a learning strategy. A disparate learning strategy is received from the learner specific to the training course. The disparate learning strategy is applied to the training course. The training course is presented to the learner in order based on the disparate learning strategy.
U.S. Pat. No. 7,925,200, disclosed a communication system for communicating with students in an education environment includes a plurality of remote units, a base station that receives messages from the remote units, a processor, a memory, and a display simultaneously visible to all users of the remote units. The base station receives a response to a current question from a remote unit. The processor determines whether the current response is a valid response, and uses the display to visually indicate to a user of the remote unit whether the response is valid.
U.S. Pat. No. 8,092,227, disclosed a method and system for assessing a student's understanding of a process that may unfold, e.g., overtime and space. The present invention provides a sophisticated approach of directing students to perform self-explanation, and enables instructors to enhance the value of this pedagogical process by providing meaningful and rapid feedback in a classroom setting.
U.S. Pat. No. 8,137,113, disclosed a computerized learning system is provided. The computerized learning system may include a learning application program executable on a computing device. The learning application program may have a user interface configured to present a challenge to a user and receive a user response to the challenge. The user interface may feature a support system configured to present support to aid the user in responding to the challenge. To adjust the support provided to the skill level of the user, a scaffolding engine may be provided to determine a scaffolding level of the user for a skill, and the support system may be configured to adjust the support in response to the scaffolding level. In this manner, support for the user may be more appropriately tailored to the user's ability and change dynamically in accordance with the user's progress.
U.S. Pat. No. 8,195,749, disclosed a mobile device or a sender's PC, notebook, PDA or laptop creates questionnaires and sends it to other recipient devices. The questionnaire is created by user of mobile device using audio inputs for a questionnaire preamble and for preambles for a question. A server in the network incorporates other generic portions of the questionnaire. It collates results received and send it to user who made/sent the questionnaire. Thus, a user can make adhoc questionnaires, send them to recipients and receive the results. This makes it easy for a user to create, disseminate, conduct questionnaires or surveys on mobile handsets and to collect results for processing and storage.
U.S. Pat. No. 81811111 B1, The system and method for providing social context to digital activity combines mobile device contact information with user-provided website information to aid users when browsing the Internet. Users of mobile devices define identifications of themselves for websites, so that when another user in their contact list is browsing the Internet, an indicator is able to indicate that he is a known contact. The determination of whether the person is a known contact based on the identification definitions is able to be implemented either by direct interfacing between the host website and a server which stores the identification definitions, a browser plugin which communicates with the server or an API provided by the server or a mobile device.
U.S. Pat. No. 2008/0215607, disclosed a computer-based method for generating intelligence from social media data, such as blog data, that is publicly available on the Internet. A server is provided that runs a tribe analysis tool, and the method includes accessing a set of the social media data with the tribe analysis tool. The social media data is associated with a plurality of network users or authors. The method continues with operating the tribe analysis tool to identify members of a tribe from the authors by processing the set of social media data to determine the authors having associated portions of the social media data that satisfies tribe membership criteria. Common interests for the identified members of the tribe are determined by processing the social media data associated with the tribe authors. A report is generated for the tribe that includes information related to the set of common interests and additional generated tribe-based intelligence.
U.S. Pat. No. 6,302,698, disclosed a learning system is provided which includes a plurality of student units for use by students, a teacher unit for use by a teacher, and a plurality of master storage devices that store information reproduced by the student units.
U.S. Pat. No. 6,411,796, disclosed a collaborative learning system and method for implementing innovative criteria fashioned into an electronic learning experience that can be utilized at great distances.
U.S. Pat. No. 6,301,462, disclosed a learning system includes a teacher station and a plurality of student stations for holding learning sessions between a teacher and a plurality of students over a plurality of interactive communication channels.
U.S. Pat. No. 6,733,295, disclosed a method of supporting mass human-interaction events, including: providing a mass interaction event by a computer network (100) in which a plurality of participants (102) interact with each other by generating information comprising of questions, responses to questions and fact information for presentation to other participants and assimilating information: and controlling, automatically by a computer (104) the rate of information presentation to each participant, to be below a maximum information assimilation rate of each participant.
U.S. Pat. No. 7,092,821, disclosed an invention preferably is a teaching and learning method and system for improving the educational process of students by increasing the interaction between student and teacher preferably. The system preferably includes at least one teacher console, at least one communications server, at least one student console, and at least one database.
U.S. Pat. No. 20020192631, The present invention is to provide a real time learning system established between at least one teacher's computer and at least one learner's computer over the Internet. Each of the teacher's and learner's computer has a video platform of real time learning coupled to a server of real time learning-over the Internet, and enables each teacher or learner to send personal data to the server capable of classifying and mating qualified teachers with qualified learners over the Internet and carrying out an interactive teaching between the teacher's and the learner's computers.
U.S. Pat. No. 20050050168, disclosed a system and method is provided for the collection and automate dispatching of assignments and news from a teacher to their students and parents. This involves registering members and assigning them roles, scopes and groups based on scheduling and other data pulled from the school/district's database, capturing assignment data from the teacher or student assistant through a web form, constructing custom homepages and assignment messages for each student and parents, and transmitting those messages to the right parties.
U.S. Pat. No. 20050266288, disclosed an invention which provides a learning system wherein students are provided with course content via the Internet and perform learning activities online. The students can be paired with teachers and other students as needed for learning. The system provides monitoring of students' activities with the learning material, and provides ranking of student abilities and needs, teacher abilities and weakness, and content effectiveness, and can match teachers and students based on student needs and teacher abilities to meet those needs. The system allows for dynamic updating of content, and provides suggested content based on effectiveness. Video conferencing with teachers can be scheduled.
U.S. Pat. No. 20080014569, disclosed a collaborative computer-based learning allows a group of users to access, share, and contribute content. A computer-based system can be accessed by a community of users over a communications network. A data storage device can store data comprising items of teaching content and items of user content, such that the data is accessible by the community of users. A set of collaborative system tools can provide users with the ability to create an item of user content associated with items of teaching content or with other items of user content. An annotation mechanism can provide users with the ability to comment on items of teaching content or items of user content in the form of an annotation that is then stored in the data storage device. The annotation mechanism is configured to merge the annotation with the associated item of teacher or user content and generate merged content with the annotation overlaid on the associated item of teacher or user content.

The present invention, unlike the above patents and the patents cited within those patents, (please see the accompanying Cited Patents list), is concerned with providing educators and their students a means for safe and transparent digital communication and collaboration in an open network environment that allows for connection from a multitude of social media and digital communications technologies as well as the ability to share user driven content from any Internet source.

Unlike the fore-mentioned patents this invention does NOT propose to provide, new training methodologies; new teaching systems; new computer-based teaching systems; new education methodologies; new instructional systems; specific user information assimilation; instruction or classroom management functionality; social media management; new development of cognitive skills; new learning materials or learning material management; new course development, structure, delivery or registration; a controlled learning environment; problem solving algorithms; performance assessment tools; automated assignment generation; new content creation tool; new event-stage management systems; new questionnaire generator or delivery system or newly designed user-matching tools or systems.

This invention is not dependent upon any specific curriculum or curriculum delivery methodologies and there are no required learning outcomes or claims related to improved learning . . . specifically this invention claims to increase teacher/student access, communication and collaboration online.

This Invention Specifically Provides a Means for:
Educators to reach out to students on a variety of online, digital and social media technologies in a mutually agreeable and safe manner.
Achieving full transparency in digital communication among educators and students.
Monitoring capability for digital communication among educators and students.
Safe sharing of user driven content in an open network environment.
Unmingling online social lives between educators and students.
Gamification as a means of student recognition.

### BRIEF SUMMARY OF THE INVENTION

This invention is a new method and computer-based apparatus that allows teachers and students to chat online and send digital messages in a transparent and safe manner. The transparency is provided by a dialog and message monitoring portal. While registration, login and system access can be integrated through the application program interface or API of most social media technologies, all digital communication is accessible to school administrators and parents. All users agree to transparent communication and each agrees to the open nature of the dialog. This isn't to say that communication between one teacher and one student is made available to all users on the application; digital content is made available only to the teacher's school administrator and the parent of the student respectively unless otherwise approved by the student, teacher or school administrator.

### BRIEF DESCRIPTION OF THE DRAWINGS

The above and other objects of the invention may be more readily seen when viewing in conjunction with the accompany drawings and screenshots wherein:

FIG. 1 shows a screenshot of a Facebook account with the TeaChatCafe app (software application) opened in front of the Facebook platform, showing the link to the TeaChatCafe application (circled in red) used by the Facebook account owner to launch the TeaChatCafe app. Also, notifications received at the app link (small red square box) are shown. Two types of notifications are sent to the user's Facebook account from the TeaChatCafe app; one notifies the Facebook user that a student or teacher within the Facebook user's “circle” members list (“circles” represent schools, classrooms, or extra-curricular groups, i.e. sports, debate club) has sent a message, the other notification provides the online status (i.e. online and available to chat) of users within the Facebook account owners “circles.” Users of the TeaChatCafe app have the ability to control their online status and related notifications to other users registered at TeaChatCafe—this allows teachers or students to decide when other members of their circles can connect to them online.

FIG. 2 shows the same screenshot in FIG. 1 but emphasizes the ability of a TeaChatCafe registrant to leverage TeaChatCafe without leaving Facebook, and while keeping their social lives separate.

FIG. 3 shows the “My Circles,” list feature. This allows users to move in and out of separate conversations and collaborate with different teachers, groups and students within their school circle without ever leaving the app.

FIG. 4 shows the App Library (or Resource Library) feature of the TeaChatCafe application which allows school administrators to stage access to other approved digital resources from the TeaChatCafe application in a meaningful and organized way. Administrators and their school populations are overwhelmed with the newly emerging multitudes of free online tools, this features will allow administrators to circumvent this issue.

FIG. 5 shows a larger image of the TeaChatCafe user interface, note that user photos are replaced by avatars which will be covered in more detail within the Claims section of this document.

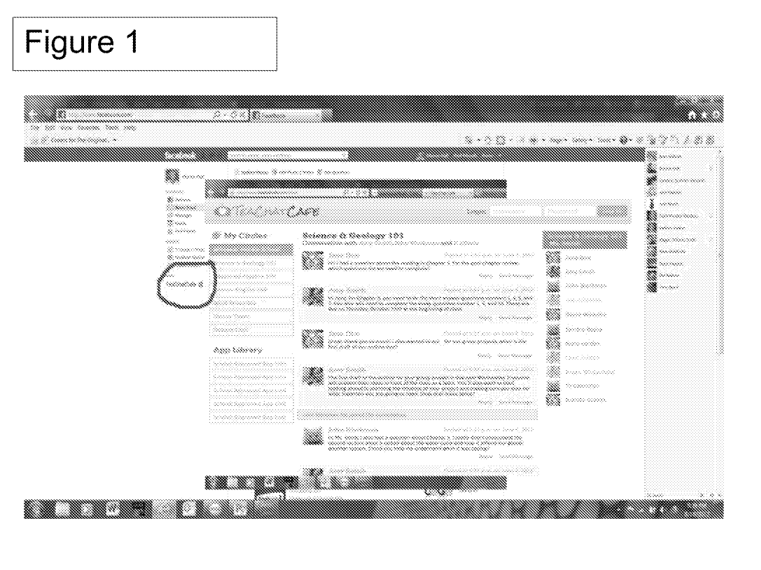

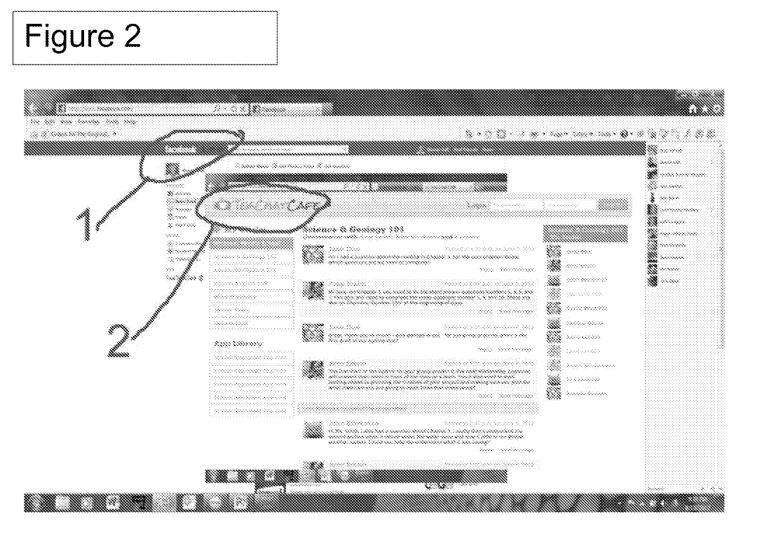

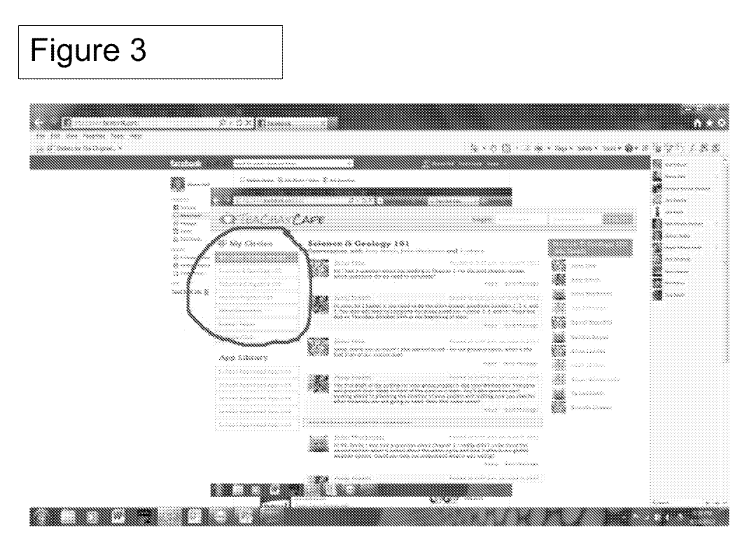

FIG. 6 shows a sample UI/UX configuration of a chat/message monitoring process:
1. Teacher Signs onto the TeaChatCafe Application
2. Student Signs onto the TeaChatCafe Application
3. Users Chat, Collaborate, Share
4. Chat Dialog, Messages, Content and Links are Stored and Organized; with Pre-Determined Word and Term Search Functionality Running in the Background.
5. User Driven Content is Made Available to Review in Administrators' Dashboard
6. Administrator Signs onto the TeaChatCafe App Dashboard

FIG. 7 shows and example of a UI/UX content submission process (Students, teachers, and parents are able to share digital content (including photos and video) with the school population without linking socially online. For example, a parent takes a great photo of the quarterback at Friday night's football game. She posts the photo to her Facebook account, she also clicks on the link to the TeaChatCafe app and submits the photo to school administrators for approval. The school administrator (or approved monitor) signs onto the TeaChatCafe Dashboard Monday morning, approves the photo and in an instant makes the photo available to the entire school population. The quarterback in the photo, who doesn't know the parent who took the photo personally, can now grab the photo from TeaChatCafe and post it to his Facebook wall (never having to “friend” the parent in order to share the photo.). Users of the TeaChatCafe app do not have to be Facebook (or other social media) users in order to submit or share content online; the software can be used independently of other platforms or integrations, or thru the software extensions including bookmarklets for example, or an application program interface (API).
1. User Submits Content and Request a “Share-Level,” (“Share-Level” denotes a particular classroom, extracurricular group, or the entire school and/or all users on TeaChatCafe associated with their school.)
2. Content is Stored
3. Content is Reviewed
4. A Decision is Made
5. Content Not Approved, Discarded, Submitter Notified
6. Content Approved and Shared with Requested Share-Levels (or circles).

FIG. 8 shows a screenshot to demonstrate that users of the TeaChatCafe app can register and integrate with multiple social media platforms.

FIG. 9 shows the chat/message portal associated with the monitoring dashboard.

FIG. 10 shows user status and activity displayed in the monitoring dashboard.

FIG. 11 shows an example of one database schema.

FIG. 12 shows the open source and modular nature of the architecture.

FIG. 13 shows the gamification elements of the application, please see the Claims section for additional detail.

FIG. 14 shows an example of non-user specific demographic data that can be captured, organized and served up thru a visual plotting tool from with the TeaChatCafe application. Please see the Claims section for further details on the social networking analysis data capturing feature of this invention.

1. A computer-based method and apparatus for providing transparent digital communication for educators and their students.
a. The method of claim 1 wherein educators connect with their students in a safe and transparent manner comprises of an apparatus that interfaces with popular forms of digital communication and social media platforms capturing the digital content created by both educator and student in an meaningful way, hence making dialog and other digital content available to an approved monitoring source given access by the providing educational institution or governing body, i.e. school districts. The method of transparency is continued by providing a means for all users to be completely informed of the monitoring process upon user registration.

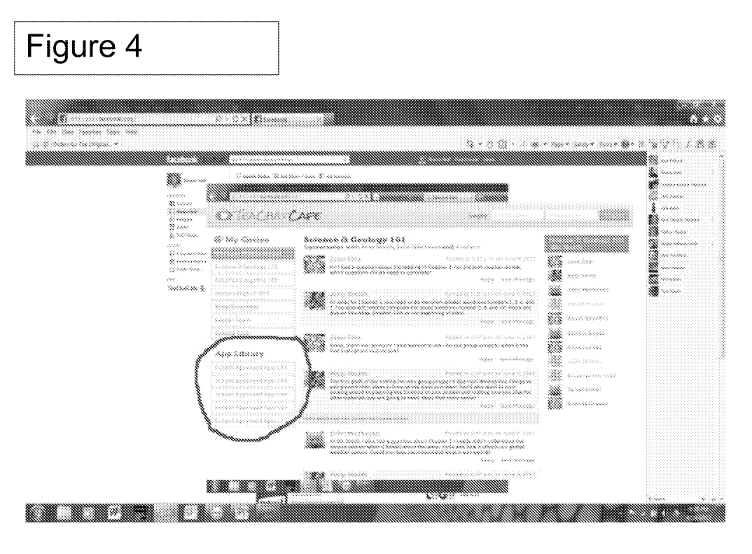

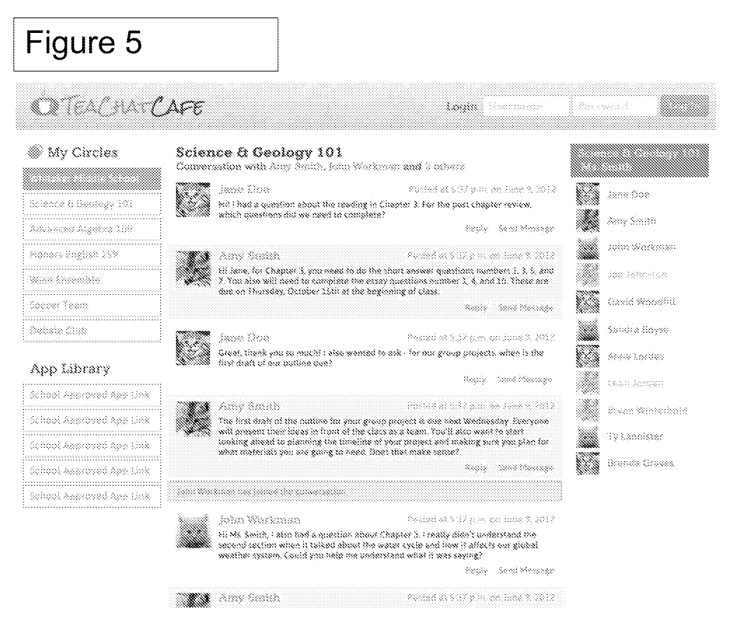

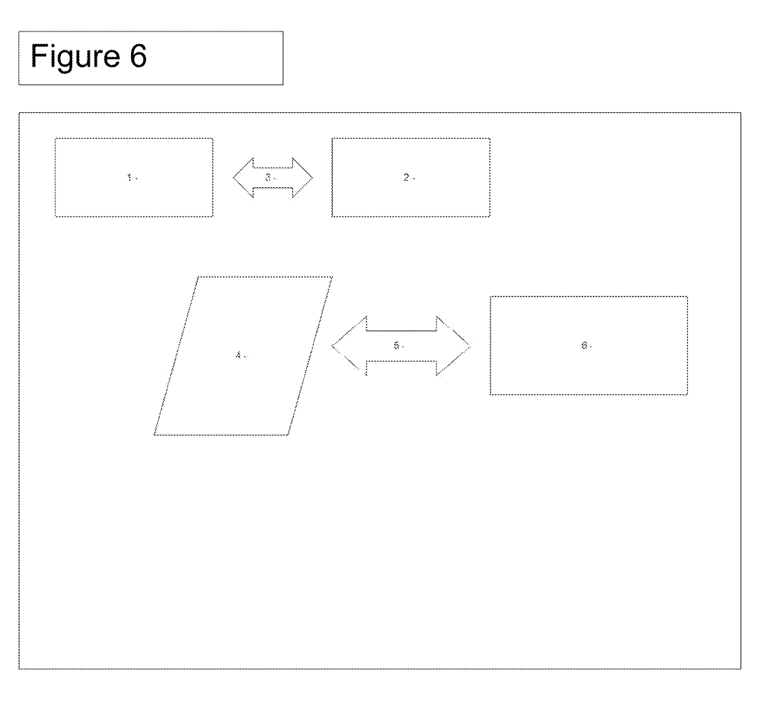

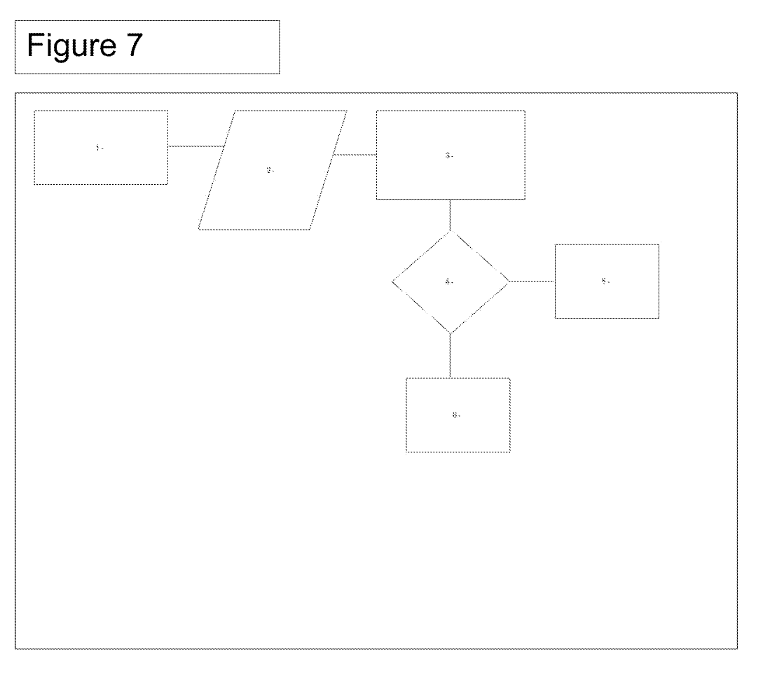

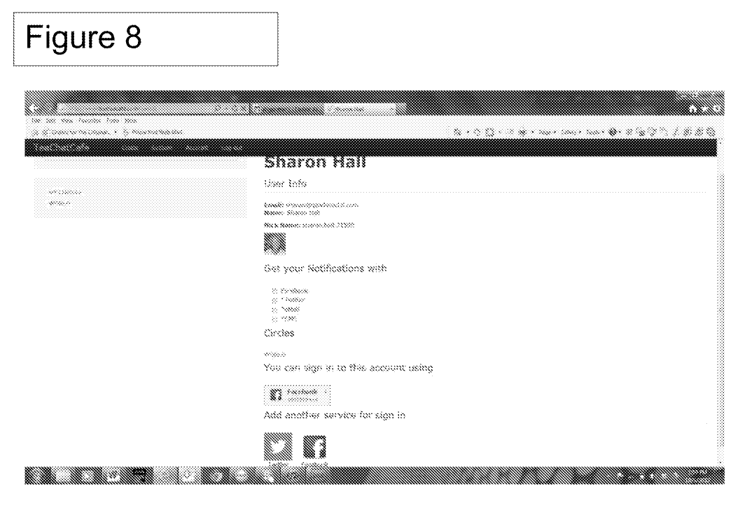

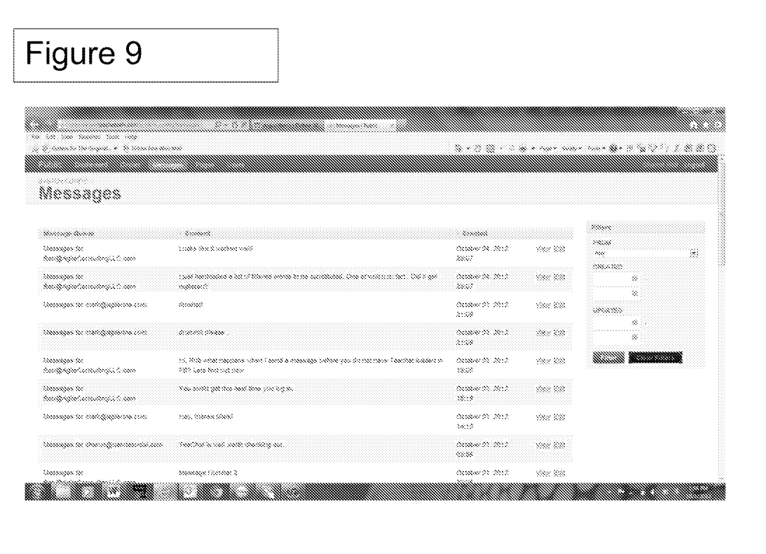

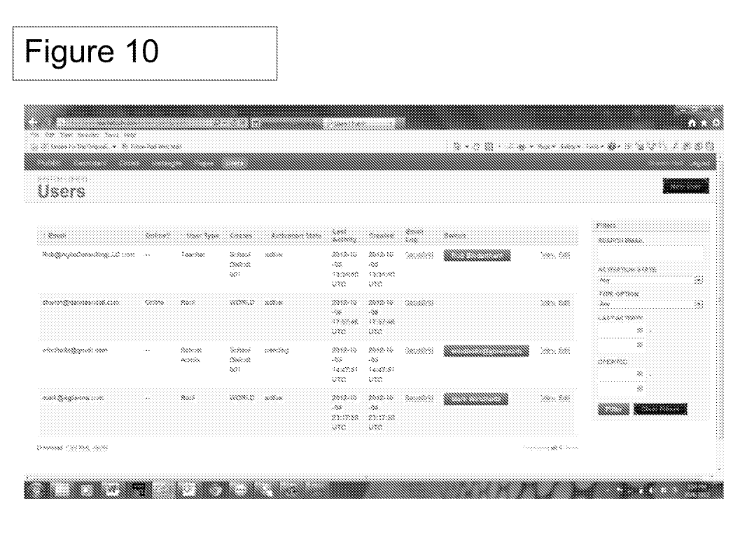

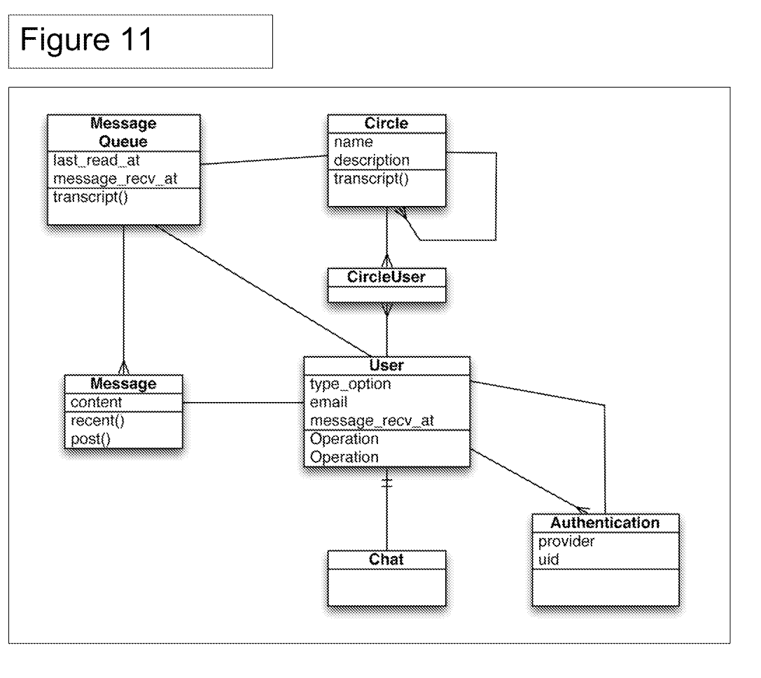

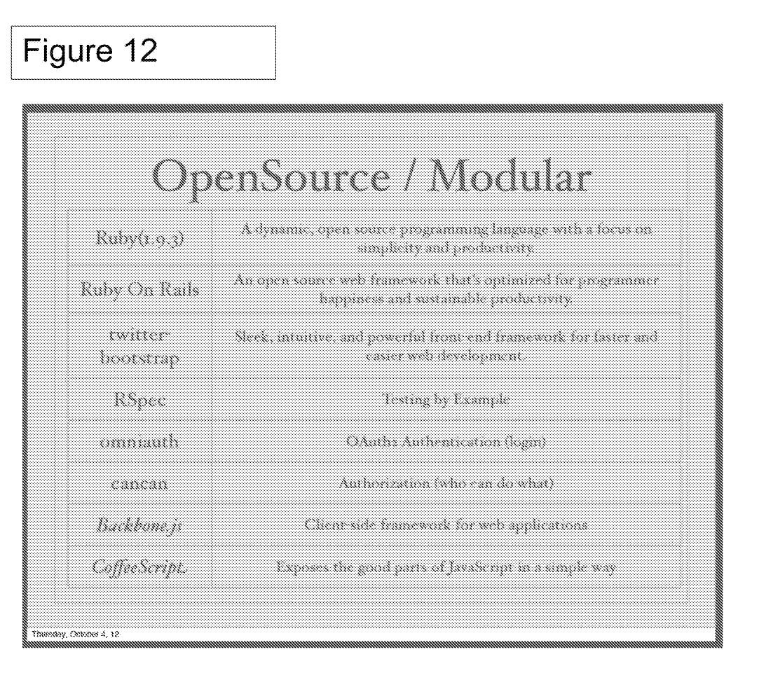

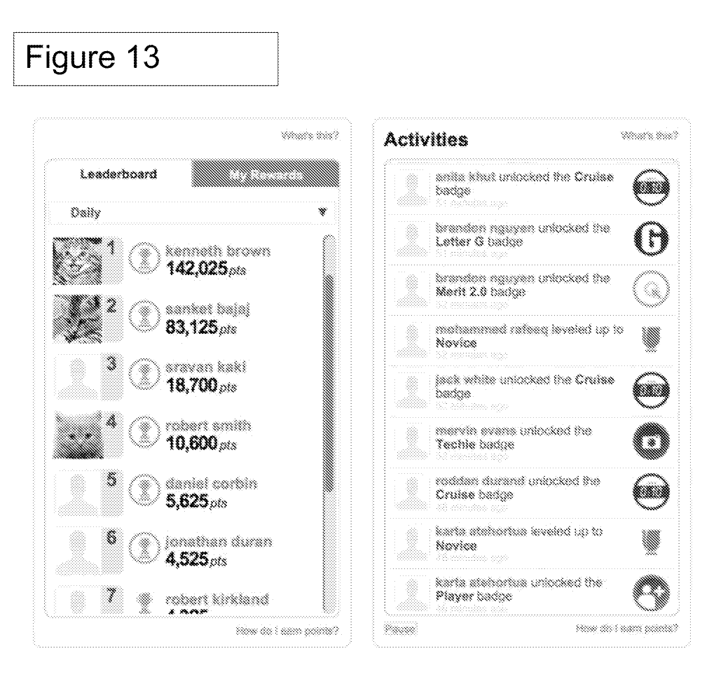

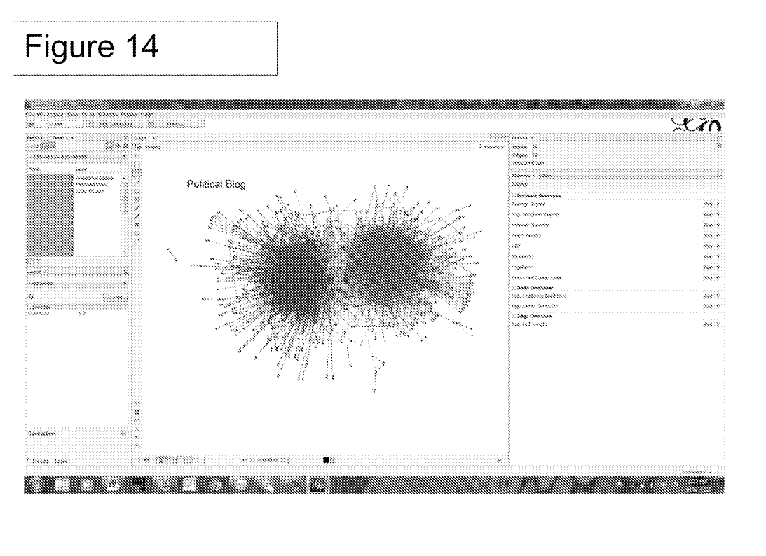

2. A computer-based method and apparatus for providing a means by which school administrators can make available an array of digital and online or computer-based resources in an organized and meaningful way for their respective school communities.
a. Less than five years after the launch of Apple's App Store, mobile applications have become one of the primary ways people communicate, shop, organize their lives, play, and even work. But in this new “App Age,” school administrators and their school communities face too much of a good thing. Free online resources and downloadable apps are so numerous that leveraging a multitude of “single use” applications can be overwhelming and counterproductive.
b. The method of claim 2 is comprised of providing a “dashboard,” or interface permitting school administrators to organize links to an array of digital resources in a manner that is meaningful to their respective communities and make this list of links available through this invention's user interface as demonstrated in FIG. 4 of the drawings documentation.
c. A feature of this invention made available by this claim enables administrators to leverage the user network created by this invention to send out critical or emergency information to their entire population in an instant. Once registered at the app, teachers, students, and parents can instantly receive critical or regularly scheduled information via their platform of choice, i.e. text message, email, Facebook message.

3. A computer-based method and apparatus that allows the community of an educational institution, (including administrators, teachers, students and their families) to share content from any Internet or digital source including social media platforms, without innermingling their online social lives.
a. User driven content includes but is not limited to image files, video, text, files and links.
b. The method of claim 3 is comprised of an upload and storage process connected to a secure monitoring portal or user interface that includes the functionality of approving or discarding the information. Once approved, the file is associated with a database record consisting of the file name and approval status. Once the approval toggle is switched “on” the file is uploaded to the corresponding “share-level,” (as described in the specification documentation) file directory for accessibility of all approved users.

4. A computer-based method and apparatus that allows educators to apply gamification to an online transparent communication platform encouraging student and parent involvement as well as recognition which can provide a means for a variety of recognition offerings, from local business rewards and coupons to scholarships.
a. Gamification is the use of game elements and game design techniquest in non-game contexts. Game elements include, but are not limited to:
i. Progression
ii. Points
iii. Levels
iv. Rewards
v. Avatars
vi. Quests
vii. Badges
viii. Social Graph
b. The method of claim 4 is an educator specific interface that allows an educator to enter in free-form any challenge (or quest) they would like to submit to their student population. Once the challenge (or quest) is formed the system will prompt the educator to assign progression milestones, associated points per milestone achievement, if the milestone achievement includes moving to higher levels or more difficult challenges, what rewards are associated with the points achieved, and if badges (image icons that denote a specific achievement) are awarded. The educator will also be prompted to view and make available to their participating students accommulated user achievement data in a graph or leaderboard that supports comment posting. Please see FIG. 13 in the drawing files for an example of gaming elements including a leaderboard.

5. A computer-based method and apparatus that thru its core functionality collects non-user specific demographic data on topics and interests across regularly submitted user-driven content.
a. The method of claim 5, wherein the accessing of the user data comprises aggregating data posted by the plurality of authors on the digital communications network, the method further comprises repeating the accessing step after a period of time to include additional postings by the plurality of authors to the digital communications network. Data is aggregated by a specific topic not by user so the data is specific to a demographic not to individual users.
b. Please see FIG. 14 of the drawings file as a graphic based example of the aggregate data output. The example in FIG. 14 shows user activity at a political blog which requests that users enter their political party affiliation and demonstrates which political party is commenting on specific issues, i.e. democrats commented X number of times on the recent presidential debate and republicans commented X number of times.
